(19) United States
(12) Patent Application Publication
(10) Pub. No.: US 2026/0209965 A1
(43) Pub. Date: Jul. 23, 2026

(54) Thermal power plant cogeneration facility, with an electrical energy conversion system (ECS) and a water electrolysis system (HTE) for the co-production of hydrogen and electricity with modulation of electricity production

(71) Applicant: COMMISSARIAT A L'ENERGIE ATOMIQUE ET AUX ENERGIES ALTERNATIVES, Paris (FR)

(72) Inventors: Nicolas TAUVERON, GRENOBLE (FR); Pierre DUMOULIN, GRENOBLE (FR)

(21) Appl. No.: 19/449,733

(22) Filed: Jan. 15, 2026

(30) Foreign Application Priority Data
Jan. 22, 2025 (FR) 2500652

(51) Int. Cl. C25B 9/65; C25B 1/042; C25B 9/67; C25B 15/08; G21D 1/02

(52) U.S. Cl. CPC C25B 9/65; C25B 9/67; C25B 15/08; G21D 1/02; C25B 1/042

(57) ABSTRACT

Using optimal indirect thermal coupling between a thermal power plant and a hydrogen production unit by high-temperature electrolysis via a withdrawal branch connection made in a fluid branch of the power plant's thermodynamic conversion cycle to install, on the one hand, a thermal storage tank to provide the heat necessary to preheat the steam intended for the cathodes of the HTE unit and, on the other hand, a pneumatic and thermal storage tank to supply pressurized hot air to the anodes.

### TECHNICAL FIELD AND BACKGROUND

The present invention relates to the field of electricity generation facilities using a thermal power plant.

Herein and within the context of the invention, the term “thermal power plant” means any power plant that generates heat for electricity production and which functions using a heat source according to the principle of thermal machines and comprises a system for converting thermal energy from the heat source into electricity (ECS), notably a Rankine cycle.

A thermal power plant in accordance with the invention may be:
a nuclear power plant comprising a steam turbine;
a “flame” combustion power plant, comprising a boiler (coal, fuel oil, gas or biomass) and a steam turbine or comprising an internal combustion engine (fuel oil, gas, etc.) and a gas turbine, a diesel engine or a combined cycle engine including a gas turbine and a steam turbine;
a power plant that recovers pre-existing heat (thermodynamic solar, geothermal steam, etc.) comprising a steam turbine;
a power plant with at least one salt reservoir heated by an electrical resistance, comprising a steam turbine;
a power plant using any other carbon-free heat source whose features, notably its temperature, allow conversion into electricity.

A nuclear power plant that is suitable for use in the context of the invention may have one or more light water nuclear reactors (LWR), notably pressurized water reactors (PWR) with conversion cycle inlet temperatures of about 300° C., or boiling water reactors (BWR), or one or more fourth-generation reactors (GEN IV), notably as small modular reactors (SMRs) or advanced nuclear reactors (AMR-Advanced Modular Reactor), with conversion cycle inlet temperatures above 500° C., typically of about 550-700° C. These may be liquid metal-cooled fast neutron nuclear reactors, notably liquid sodium-cooled reactors called RNR-Na or SFR (Sodium Fast Reactors), which are part of the GEN IV family of reactors. They may also be molten salt-cooled fast neutron nuclear reactors or MSR (Molten Salt Reactors).

Herein and within the context of the invention, the term “SMR reactor” has the usual technological meaning, namely a nuclear fission reactor with a size and power smaller than those of conventional LWR reactors, whose boiler is manufactured in a factory and transported to a nuclear facility for installation. The compact, low-power boiler may also be suitable for naval applications, known as shipboard applications.

Herein and within the context of the invention, the term “nuclear boiler” means the tank, known as the reactor tank, and also all the components and parts of the fluid circuit, notably the reactor core, which generates heat through nuclear fission reactions and is housed inside the reactor tank.

Within the context of the invention, hydrogen production may be achieved by high-temperature water electrolysis (HTE, which stands for High Temperature Electrolysis, or HTSE, which stands for High Temperature Steam Electrolysis), also using solid oxides (SOEC, which stands for Solid Oxide Electrolysis Cell).

The main object of the invention is to optimize the carbon-free mass production of hydrogen by means of a low-carbon energy source within the context of an electricity grid which undergoes significant fluctuations.

The invention is directed towards providing modulable electricity production while at the same time ensuring constant and continuous production of hydrogen with a constant and continuous heat source.

Although described with reference to a pressurized water nuclear reactor power plant, the invention applies to any other thermal power plant as mentioned previously, comprising a cycle for conversion of heat energy into electricity, notably a Rankine cycle.

In the context of climate and energy transition, the nuclear industry faces several challenges for the future. Specifically, to meet the energy and societal challenges of tomorrow, it will be advisable to design nuclear reactors that will:
be able to limit the need for “environmental” liquid cooling sources (rivers, streams, sea) and the associated discharges into the environment;
be more flexible and thus more complementary to other “renewable” energies (RE), in order to respond to fluctuating electricity demand and the intermittency of RE production;
decarbonize processes by supplying heat to consumer industries (desalination, heating networks, hydrogen, etc.) while at the same time increasing energy efficiency;
   and to do so without reducing the profitability of the facility, either by taking economic advantage of the new services provided (for example in terms of electricity grid stability by operating with charging and frequency monitoring). The aim is thus to integrate its electricity and heat production efficiently into a low-carbon power system.

A pressurized water nuclear reactor (PWR) conventionally comprises three cycles (fluid circuits), the general principle of normal operation of which is explained hereinbelow with reference to FIG. 1. The temperatures and efficiency are indicated for illustrative purposes. The primary circuit 1 is a closed-loop fluid circuit mainly comprising the reactor core 2, at least one steam generator (SG), acting as a primary heat exchanger 3, and a hydraulic pump 4 to circulate the heat-transfer fluid, which is water kept in the liquid state within the reactor's operating temperature range, typically about 320° C.-330° C. during normal operation. The other items of equipment, such as a pressurizer and all the devices required to ensure operation under the required safety conditions, are not described here.

Thus, the water under high pressure in the primary circuit collects the energy supplied in the form of heat by the fission of uranium nuclei in the reactor core 2.

This high-pressure, high-temperature water, typically at 155 bar and 320° C.-330° C., then enters the intermediate exchanger 3 and transfers its energy to a secondary circuit 5, which also uses pressurized water as a closed-loop heat-transfer fluid.

This secondary circuit 5 comprises the intermediate exchanger 3, a turbine 6 comprising a high-pressure body 60 and a low-pressure body 61, a condenser 7 and a hydraulic pump 8 to circulate the water in the form of steam as a heat-transfer fluid.

Thus, in this secondary circuit 5, the water in the form of steam, at high pressure, typically about 70 bar, is expanded in the high-pressure body of the turbine, and then superheated before continuing its expansion in the low-pressure bodies 61. The turbine drives an alternator 9 which generates electricity.

The water in the secondary circuit is then condensed via the condenser 7 in a third cycle, the cooling cycle 10, as a “cold” source. This cycle 10 mainly comprises wet-air cooling towers 11, which are towers with a hollow centre, in which a natural air current is created, entering at the bottom and exiting at the top. As it passes through, this air current collects the heat contained in the water of the cooling circuit and disperses it into the atmosphere in the form of a cloud of steam. The operation is repeated permanently, in which the water is spread into fine droplets, which firstly allows for effective heat exchange between the water and the air, and thus brings the water to a temperature close to that of the ambient air, and secondly saturates with steam the air flow circulating from upwards in the tower. Part of the water flow evaporates in tower 11, while the rest falls as rain into the basin below the tower, in which it is pumped back up to cool the condenser 7. The evaporated water is replaced with tertiary water, called “environmental” water, which is pumped upstream from a stream, a river or the sea. This significantly increases the temperature of these waterways, with the exception of coastal power plants, which in hot weather and/or when the flow rate of these waterways is low can lead a nuclear facility operator to reduce their power output or even shut them down, even if this loss of production over a full year is not significant. Certain power plant projects include air condensers, for which this problem will not arise.

Direct cooling may also be envisaged.

As shown in FIG. 1, by way of example, the thermodynamic efficiency of a PWR is from about 32% to 36%, the temperature of the water at the inlet to the condenser 7 is about 20° C. and 35° C. at the outlet.

In the conventional PWR sector, reactors are classified by major families of uses:
“electricity-generating” reactors, which are dedicated solely to the production of electricity;
“cogeneration” reactors, dedicated to both electricity and heat production or to electricity and, where appropriate, heat and hydrogen production, simultaneously or otherwise.

As detailed in [1], one principle of cogeneration of electricity and heat using a nuclear reactor consists in modifying the design of the energy conversion cycle so that heat is released to the cold source at a temperature that allows it to be upgraded. This principle is mainly applied to facilities such as those intended for seawater desalination and urban heating, in which the heat required is at a relatively low temperature, typically about 150° C.

Limiting global warming entails minimizing heat loss at all levels, in particular at the cold source of a thermodynamic facility. This cogeneration objective is all the more relevant for nuclear reactors, as industrial or domestic heat is often conventionally obtained by burning fossil fuels, which are responsible for greenhouse gas emissions.

Recently, numerous studies have highlighted the possibility of combining nuclear power reactors with hydrogen production units based on high-temperature water electrolysis so as to constitute cogeneration facilities that can efficiently produce electricity and hydrogen: [2], [3], [4].

Water electrolysis is an electrochemical reaction that breaks down water into oxygen and hydrogen gas using an electric current, according to the reaction:

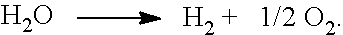

To achieve water electrolysis, it is advantageously performed at high temperature, typically between 600 and 950° C., because some of the energy required for the reaction can be supplied by heat, which is cheaper than electricity, and the reaction takes place more efficiently at high temperature and, lastly, it can dispense with the need for a catalyst.

To perform high-temperature electrolysis, it is known practice to use a reactor, also known as an SOEC (Solid Oxide Electrolysis Cell) electrolyser, consisting of a stack of basic units, including each a solid oxide electrolysis cell made up of three layers (anode, electrolyte and cathode) stacked on top of each other, and interconnecting plates, for example made of metal alloys, also known as bipolar plates or interconnectors. The interconnectors have the function of ensuring both the passage of electrical current and the circulation of gases in the vicinity of each cell (injected steam, hydrogen and oxygen extracted in an HTE electrolyser) and of separating the anode and cathode compartments, which are the gas circulation compartments on the anode and cathode sides of the cells, respectively. To perform high-temperature steam electrolysis HTE, H₂O steam is injected into the cathode compartment. Under the effect of the current applied to the cell, the dissociation of water molecules in steam form takes place at the interface between the hydrogen electrode (cathode) and the electrolyte: this dissociation produces hydrogen gas H₂ and hydroxide ions OH⁻. The hydrogen is collected and evacuated at the outlet of the hydrogen compartment. The hydroxide ions OH migrate through the electrolyte and recombine as oxygen at the interface between the electrolyte and the oxygen electrode (anode).

To increase the flow rates of hydrogen and oxygen produced, it is known practice to stack one or more basic electrolysis cells on top of each other, separating them with interconnecting devices, usually called interconnectors or bipolar interconnecting plates. The assembly is positioned between two end interconnecting plates that support the electrical and gas supplies of the electrolyser (electrolysis reactor).

A high-temperature water electrolyser (HTE) thus comprises at least one, and generally a plurality of, electrolysis cells stacked on top of each other, each basic cell being formed of an electrolyte, a cathode and an anode, with the electrolyte sandwiched between the anode and the cathode.

In continuous operation, the gas supply is turned on at a constant flow rate and an electrical power source is connected between two terminals of the high-temperature electrolyser HTE stack so as to circulate a direct electric current therein.

Thus, an HTE electrolyser requires a combined supply of thermal and electrical power upstream to bring the reagents to the temperature necessary for electrolysis and, within itself, a supply of electrical power to perform the electrolysis.

In addition, a neutral drainage gas, such as air, may also be required on the anode compartment side. The percentage of this gas has a significant effect on the overall electricity consumption. Furthermore, the dilution of the oxygen produced in this gas at the outlet of the HTE electrolyser is beneficial from the point of view of facility safety.

The efficiency of converting electricity into hydrogen is a key factor in ensuring the competitiveness of HTE technology. Electricity consumption occurs mainly during the electrolysis reaction itself, but a significant part, typically around 30% of the electrolyser's consumption, comes from the thermal/hydraulic fluid management system, i.e. the architecture external to the electrolyser and the management of fluids and thermal energy in this architecture, mainly due to the pressure at which the hydrogen will be produced, typically about 30 bar.

Moreover, a significant part of the system's consumption comes from high-temperature thermal requirements for both the anode and cathode compartments, mainly:
hydrogen compression, which also represents a significant energy cost,
heating of steam,
compression of the inlet air, which also represents a significant energy cost,
heating of the inlet air.

Finally, it is known practice to operate an HTE electrolyser under pressure, typically at 10 bar, so as to obtain better efficiency, notably due to the reduced need for compression of the hydrogen produced.

Publication [4] proposes sending all the electricity produced by the nuclear reactor to the electrolysis production unit operating under pressure, in addition to a certain amount of heat. A simulation of this facility with the numerical values for temperatures, pressures and fluid flow rates is reproduced in FIG. 2, with the numerical references of the elements corresponding to those in FIG. 1, except that the nuclear unit is referenced as 100, the hydrogen production unit as 200, the heaters as 62 and a heat exchanger 12 acting as a steam transformer.

It is conceivable that part of the electricity produced by a nuclear reactor may be upgraded on the electricity grid and that another part may be sent to an electrolysis unit, in addition to a certain amount of heat.

Patent application WO 2024/133496 A1 proposes optimal indirect thermal coupling, i.e. without any mass transfer, between a nuclear reactor and a high-temperature electrolysis hydrogen production unit via a carefully chosen withdrawal branch connection downstream of the high-pressure body of the Rankine cycle turbine of the nuclear reactor, which will transfer the heat thus withdrawn via a closed loop between an intermediate heat exchanger and a coupling steam generator, to liquid water supplying the production unit so as to inject steam at a high temperature required to perform the electrolysis. This indirect heat supply may be performed permanently or decreasing until the heat released by the electrolysis reaction is sufficient to supply itself. This application also provides for a coupling circuit by reinjecting heat into the tertiary circuit of the reactor, which allows at least a portion of the waste heat to be recovered, i.e. the heat from the recovery of the electrolysis outlet gas cooling system that has not been used for this purpose. The reinjected waste heat may be considered as being in the low temperature range, since it is typically between 80° C. and 150° C.

With the current evolution of the electricity grid, which is increasingly connected to intermittent renewable energy systems, both the needs and prices of the electricity grid are highly variable.

Under these conditions, it is desired to be able to modulate the electricity production fed back into the grid, both upwards and downwards. Such modulation may also be seen as a margin of charge reduction relative to an initial fixed electricity production reference.

Thus, various coupling solutions have emerged to make it possible, in principle, to respond to this need for modulation.

Solutions that would only allow downward modulation by reducing heat, electricity and hydrogen production cannot reasonably be considered, as they are not economically viable and are rather technically difficult to implement.

Patent application RU2682723 proposes an electricity and hydrogen cogeneration facility with modulation of the net electrical power fed back into the electricity grid. To ensure this modulation of electrical power, the facility comprises an HTE electrolyser operating in reversible mode as an SOFC fuel cell, with storage of the O₂ and H₂ produced by electrolysis, which are recombined to provide additional steam to the Rankine cycle of the nuclear unit and thus produce additional electricity using a higher steam flow rate.

This solution has several major drawbacks, as follows:
hydrogen is not produced continuously; on the contrary, it is actually consumed when additional electricity is required. Such cycling of hydrogen production and consumption is not energetically advantageous.
oxygen and hydrogen storage facilities are required on site, which imposes significant safety constraints, a major parameter to be taken into account in the case of coupling with a nuclear reactor;
systems operating in reversible mode from electrolyser (SOEC) to fuel cell (SOFC) have not yet been tested and cannot be deployed in high-power facilities.

There is thus a need to improve nuclear cogeneration facilities, i.e. facilities for the production of electricity and hydrogen from the heat supplied by the facility's nuclear reactor(s), so that the amount of electricity production fed back into the grid can be modulated while at the same time ensuring constant and continuous production of hydrogen.

The aim of the invention is to at least partially meet this need.

### SUMMARY

To this end, one aspect of the invention relates to a cogeneration facility, intended to produce electricity and hydrogen, comprising:
at least one thermal power plant, notably a pressurized water nuclear reactor (PWR) or a boiling water reactor (BWR), comprising a system for converting the heat produced by the power plant into electricity (ECS), connected to an electricity grid;
at least one hydrogen production unit comprising:
   a fluid circuit, called the injection coupling circuit, for thermally coupling the hydrogen production unit to the thermal power plant, comprising:
      at least one steam generator, called the coupling steam generator, connected in a closed loop to a withdrawal branch connection, made in a fluid branch of the ECS conversion system,
      at least one first heat exchanger, called the coupling exchanger, connected in a closed loop to a withdrawal branch connection, made in a fluid branch of the ECS conversion system;
   at least one high-temperature electrolysis (HTE) unit, whose cathodes are connected to the coupling steam generator;
   at least one first air compressor connected to the anodes of the HTE unit;
   a thermal and pneumatic storage system comprising:
      at least one thermal storage tank connected on the one hand to the coupling generator and on the other hand to the cathodes of the HTE unit;
         at least one second air compressor connected to the coupling exchanger,
         at least one thermal and pneumatic storage tank connected on the one hand to the second air compressor and on the other hand to the anodes of the HTE unit;
            the facility being configured such that:
in the nominal operating mode of the facility, the cathodes of the HTE unit are supplied with pressurized steam produced by the coupling steam generator, while the anodes of the HTE unit are supplied with compressed air by the first compressor;
when the facility is operating with an amount of electricity required by the electricity grid that is lower than in the nominal operating mode, known as the charging operating mode, the cathodes of the HTE unit are supplied with pressurized steam produced by the coupling steam generator, while the anodes of the HTE unit are supplied with air compressed by the first compressor, and simultaneously, the thermal storage tank is supplied with heat from the coupling generator and the thermal and pneumatic storage tank is supplied with hot air compressed by the second compressor;
when the facility is operating with an amount of electricity required by the electricity grid that is higher than in the nominal operating mode, known as the discharging operating mode, the cathodes of the HTE unit are supplied with pressurized steam produced by the heat from the thermal storage tank, while the anodes of the HTE unit are supplied with hot compressed air provided by the thermal and pneumatic storage tank.

Advantageously, the liquid water supplying the coupling steam generator is demineralized water.

The term “high-temperature water electrolysis unit” is used here and in the context of the invention to refer to a hydrogen production unit comprising several high-temperature water electrolysers (HTE) in series or in fluidic parallel, each electrolyser comprising at least one and generally a plurality of electrolysis cells stacked on top of each other, each elementary cell being formed of an electrolyte, a cathode and an anode, the electrolyte being sandwiched between the anode and the cathode. The electrolysis unit may also comprise components upstream and downstream of the electrolyser(s), for example heat exchangers, compressors for the hydrogen and oxygen produced, etc. Reference may be made to FIGS. 2 and 3 of publication [5].

The first compressor and the second compressor may be a single air compressor.

Alternatively, the first compressor is different from the second compressor, with the first and second compressors being connected in parallel to the anodes of the HTE electrolysis unit and to the thermal and pneumatic storage tank, respectively.

According to a preferred application, the thermal power plant is a nuclear reactor, notably a pressurized water reactor (PWR) or a boiling water reactor (BWR), comprising:
a first fluid circuit, called the primary circuit, comprising at least one first steam generator as a first intermediate heat exchanger;
a second fluid circuit, called the secondary circuit comprising:
   at least one turbine comprising a high-pressure body connected to the first steam generator and a low-pressure body connected to the high-pressure body via at least one fluid branch,
   a high-pressure heater connected in a closed loop to the high-pressure body, to a water tank, called the feedwater tank, and to the first steam generator,
   a low-pressure heater connected on the one hand by at least one fluid branch to the low-pressure body and on the other hand by at least one fluid branch to the feedwater tank,
   a condenser connected on the one hand to the low pressure body and on the other hand in a closed loop to the low-pressure heater;
an alternator mechanically coupled to the turbine and connected to the electricity grid.

In this preferred application of a nuclear reactor, the withdrawal branch connection is advantageously made in the fluid branch between the high-pressure body and the low-pressure body of the turbine, and at the feedwater tank.

According to an advantageous configuration, the nuclear reactor is a PWR reactor comprising a steam dryer, arranged on the fluid branch connecting the high-pressure body and the low-pressure body of the turbine, the withdrawal branch connection being made at a point on the branch between the high-pressure body and the steam dryer.

The invention consists essentially, based on optimal indirect thermal coupling between a thermal power plant and a high-temperature electrolysis hydrogen production unit via a withdrawal branch connection made in a fluid branch of the power plant's thermodynamic conversion cycle, in implanting, on the one hand, a thermal storage tank to provide the heat necessary to preheat the steam intended for the cathodes of the HTE unit and, on the other hand, a pneumatic and thermal storage tank to supply pressurized hot air to the anodes.

Storage in the tanks is advantageously performed when the electricity grid to which the thermal power plant's conversion system is connected requires less electricity.

Conversely, release from storage is performed when there is increased demand for electricity by the grid.

In the nominal operating mode, the facility does not perform either storage or release of heat or air.

The term “indirect” is used here and in the context of the invention to mean that there is no mass transfer between the nuclear reactor cycles and the HTE electrolysis hydrogen production unit, and thus that heat transfer takes place through steam generators and heat exchangers.

According to one advantageous embodiment, another closed loop with heat exchangers is also used to perform indirect coupling by returning waste heat from the HTE electrolysis hydrogen production unit to the nuclear reactor. In other words, according to this embodiment, the thermal waste from the HTE electrolysis hydrogen production unit is at least partly reinjected into the nuclear reactor.

Thus, according to this embodiment, the hydrogen production unit is also thermally coupled to the nuclear reactor by a fluid circuit, called the reinjection coupling circuit, comprising at least one intermediate heat exchanger, called the coupling exchanger, connected on the one hand in a closed loop to a reinjection branch connection made in a fluid branch of the ECS conversion system, and on the other hand to at least one fluid branch at the outlet of the high-temperature electrolysis unit, so as to at least partly evacuate the excess heat from the high-temperature electrolysis unit and reinject it into the ECS conversion system.

According to an advantageous configuration, the reinjection coupling circuit comprises at least one coupling exchanger connected to a fluid branch whose inlet is connected to the outlet of the cathodes of the HTE electrolysis unit and whose outlet is connected to at least one network for evacuating the hydrogen produced.

Preferably, the facility also comprises at least one cooler connected downstream of the coupling exchanger and a gas-liquid phase separator connected downstream of the cooler to extract and condense the water contained in the mixture of hydrogen produced and steam at the outlet of the cathodes of the HTE unit.

According to an advantageous embodiment variant, the facility comprises at least two coupling exchangers connected in series with each other, and downstream of each of them, a cooler and a gas-liquid phase separator, and a compressor between the most upstream gas-liquid phase separator and the most downstream coupling exchanger.

According to another embodiment variant, the reinjection coupling circuit comprises at least one coupling exchanger connected to a fluid branch whose inlet is connected to the anode outlet of the high-temperature electrolysis unit and whose outlet is connected to at least one network for evacuating the oxygen produced.

The facility may advantageously comprise a turbine on a fluid branch whose inlet is connected to the outlet of the anodes of the high-temperature electrolysis unit and whose outlet is connected to at least one network for evacuating the oxygen produced. This turbine allows electricity to be fed back into the ECS conversion system of the thermal power plant.

According to an advantageous embodiment, the facility comprises an electrical resistor for, in the discharging operating mode, heating the air released from the pneumatic and thermal storage tank before it enters the anodes of the HTE unit. Thus, according to this embodiment, it is possible to store the air in the pneumatic storage tank at a lower temperature in the charging operating mode. Specifically, in the discharging operating mode, the electrical resistance heats the air. This avoids the need to resort to overly advanced technologies for the dedicated storage line, i.e. this avoids performing high-temperature thermal storage and a high-temperature compressor.

According to another advantageous embodiment, the facility comprises a turbine on a fluid branch whose inlet is connected to the pneumatic and thermal storage tank and whose outlet is connected to the outlet of the anodes of the HTE electrolysis unit so that, in the discharging operating mode, the air released from the pneumatic and thermal storage tank is expanded before entering the anodes of the HTE unit. Thus, according to this embodiment, it is possible to store air at higher pressure and higher temperature in the charging operating mode. Specifically, in the discharging operating mode, the hot air is partially expanded in the turbine and then sent downstream to the anodes of the HTE unit. This allows the air to be stored at higher pressure, and thus to be stored more densely.

According to an advantageous embodiment variant, the facility comprises a compressed hydrogen storage tank connected to the outlet of the HTE unit cathodes. This type of storage dispenses with, i.e. avoids the need to add, the electrical output required to operate the corresponding dedicated compressors.

According to another advantageous embodiment variant, the facility comprises a storage tank for compressed oxygen or an air-oxygen mixture, connected to the outlet of the anodes of the HTE unit. This allows the electrical output of the corresponding dedicated turbine to be added.

Although described as a preferred application with a thermal source consisting of a nuclear reactor with a Rankine cycle, the invention may be applied to other thermal power plants and to other thermodynamic cycles.

A particularly advantageous application is that of a stable thermal source directly supplying heat to the HTE unit. This may be a geothermal power plant. In this application, the electricity required to operate the hydrogen production unit comes almost exclusively from the electricity grid, with a minute part possibly coming from an ORC-type Rankine cycle functioning using the heat source considered. The discharging operating mode then makes it possible to offer charge reduction solutions to the electricity grid while having hydrogen production maintained at the same level. Such charge reductions are useful for stabilizing the electricity grid. In other words, as in this application, the electricity grid can be advantageously adapted to supply, in nominal and charging operating mode, most of the electricity required by the HTE unit.

Finally, the indirect thermal coupling proposed to transfer heat from a reactor to a high-temperature electrolysis unit, combined with thermal and pneumatic storage and, advantageously, with indirect coupling by reinjecting waste heat from the electrolysis unit offers a number of advantages, among which mention may be made of:
operation of the cogeneration facility that allows for the massive, stable and constant production of carbon-free hydrogen, even in circumstances of variations in the market cost of electricity and/or possible significant fluctuations in an electricity grid to which the thermal power plant is connected,
unchanged safety of the thermal power plant, in particular of the nuclear reactor, since the storage tanks installed in the hydrogen production unit do not entail any particular safety requirements;
no risk to the overall facility,
the operating conditions of the thermal power plant and the HTE unit remain the same and independent of each other.

Other advantages and features of the invention will emerge more clearly on reading the detailed description of examples of implementation of the invention, given for illustrative purposes and without implied limitation, with reference to the following figures.

### BRIEF DESCRIPTION OF THE DRAWINGS

FIG. 1 schematically illustrates a configuration of a pressurized water reactor (PWR) operating solely as a power generating reactor according to the prior art.

FIG. 2 is a schematic view of a configuration of a pressurized water reactor (PWR) coupled to a high-temperature electrolysis (HTE) hydrogen production unit according to the prior art.

FIG. 3 is a schematic view of a high-temperature electrolysis (HTE) hydrogen production unit thermally coupled with a pressurized water reactor (PWR) according to the invention.

FIG. 4 repeats FIG. 3 and shows the facility in nominal operating mode.

FIG. 5 repeats FIG. 3 and shows the facility in the charging operating mode.

FIG. 6 repeats FIG. 3 and shows the facility in discharging operating mode.

### DETAILED DESCRIPTION

Throughout the present patent application, the terms “upstream” and “downstream” are to be understood by reference to the direction of flow of a heat-transfer fluid within one of the fluid circuits of an electricity and hydrogen cogeneration facility according to the invention.

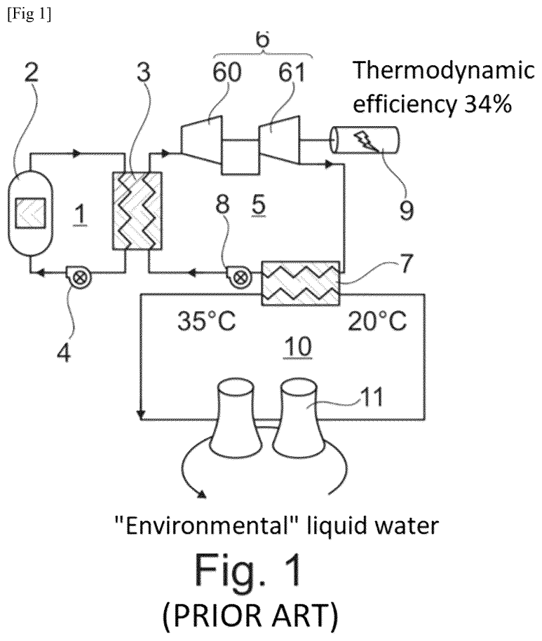

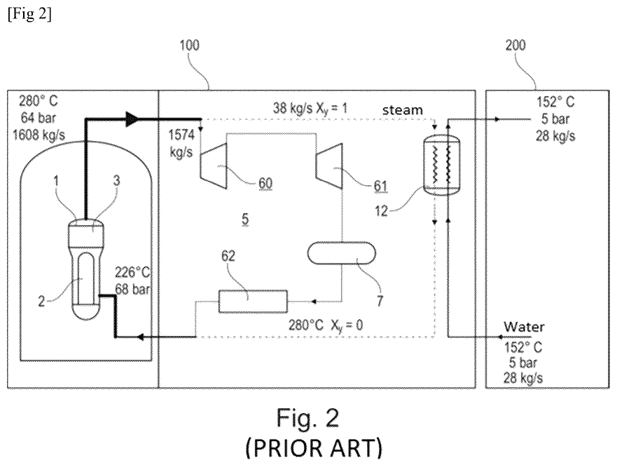

FIGS. 1 and 2 relating to the prior art have already been detailed in the preamble and will thus not be discussed hereinbelow.

For the sake of clarity, the same element according to the invention and according to the prior art is denoted by the same reference number throughout FIGS. 1 to 4.

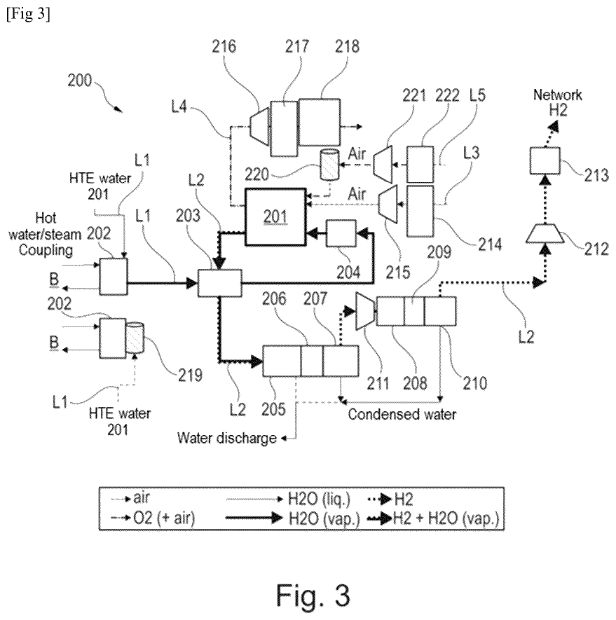

In FIGS. 3 to 6 relating to a cogeneration facility according to the invention, the PWR nuclear reactor with its Rankine cycle are not described. They can be as already exist, with the operating modes of an electricity generating cycle of the facility, and must be able to operate according to the needs of the electricity grid.

The electricity grid connected to the Rankine cycle alternator is directed towards transporting and distributing electricity to end users as a function of their needs. It is a high-voltage electricity grid operating as a function of the power demands associated with electricity usage, which must be able to accept the peak electrical power produced by the cogeneration facility.

In addition, the alternator may supply the electricity needs of the HTE unit 201, whose electrolysers require direct current, to perform high-temperature electrolysis, as detailed later.

Only the hydrogen production unit 200 according to the invention is described with its indirect thermal coupling elements with the nuclear reactor.

This hydrogen production unit 200 first comprises a high-temperature electrolysis HTE unit 201 thermally coupled to the nuclear reactor by an injection coupling circuit.

This injection coupling circuit first comprises a coupling steam generator 202 connected in a closed loop B to a withdrawal branch connection, not represented, made in a fluid branch of the Rankine cycle of the PWR nuclear reactor.

Advantageously, this withdrawal branch connection may be located between the high-pressure body and the low-pressure body of the turbine, and at the feedwater tank of the Rankine cycle. More specifically, given the temperature and pressure of the hot water/steam to be withdrawn, the withdrawal branch connection is located at a point on the branch connecting the turbine high-pressure body and the dryer, not represented in the PWR reactor.

A circulation pump (not represented) supplies pressurized liquid water via an inlet fluid branch L1 to the coupling generator 202, which generates steam after heat exchange with the water/steam in loop B.

The cathode inlet of the HTE unit 201 is connected to the coupling steam generator 202 via this fluid inlet branch L1.

A heat exchanger 203 is arranged upstream of the HTE unit 201 to exchange heat between the fluid inlet branch L1 and a fluid outlet branch L2 connected to the cathode outlet of the HTE unit 201.

In addition, an electrical resistor 204 is arranged on the fluid inlet branch L1, between the exchanger 203 and the HTE unit 201, so as to preheat the steam entering the latter.

On the fluid outlet branch L2, a first intermediate heat exchanger 205 is arranged downstream of the exchanger 203. A first cooler 206 is connected downstream of this first heat exchanger 205, and a first gas-liquid phase separator 207 is connected downstream of the first cooler to extract and condense the water contained in the mixture of hydrogen produced and steam at the outlet of the cathodes of the HTE unit 201.

A second intermediate heat exchanger 208 is arranged downstream of the first phase separator 207. A second cooler 209 is connected downstream of this second heat exchanger 208, and a second gas-liquid phase separator 210 is connected downstream of the second cooler 209, with two coupling exchangers in series with each other and downstream of each of them.

A first compressor 211 is arranged between the first phase separator 207 and the second intermediate heat exchanger 208.

On this fluid outlet branch L2, a second compressor 212 is arranged downstream of the second phase separator 210 to compress the hydrogen produced.

This compressed hydrogen produced is sent to a third cooler 213 before being injected into a hydrogen network.

The anode inlet of the HTE unit 201 is connected to a fluid inlet branch L3 on which a heat exchanger 214 and a first air compressor 215 are arranged from upstream to downstream, to pressurize and heat the air entering the anodes of the HTE unit 201.

On the fluid branch L4 at the outlet of the anodes of the HTE unit 201, an air turbine 216 and a third intermediate heat exchanger 218 are arranged from upstream to downstream. This air turbine 216 allows the upgrading of the pressure energy into electricity during expansion, more particularly by reinjecting it into the Rankine cycle associated with the nuclear reactor to which unit 200 is thermally coupled.

According to the invention, a thermal storage tank 219 is thermally coupled to a coupling steam generator 202 connected in a closed loop B to the ECS conversion system. This thermal storage tank 219 may be a steam accumulator, a phase-change material thermal storage tank, or other.

As illustrated and referenced, a single coupling steam generator 202 may be provided, with the thermal storage tank 219 also arranged on the fluid inlet branch L1 to be supplied with water intended for the injection of steam/liquid water into the HTE unit 201.

On a fluid inlet branch L5, a thermal and pneumatic storage tank 220 is connected, on the one hand, to a second air compressor 221 and, on the other hand, to the anodes of the HTE unit 201. A heat exchanger 222 for coupling heat injection from the ECS conversion system is arranged upstream of the second air compressor 221 to heat the air entering line L5. The first air compressor 215 and the second air compressor 221 may be conceived as a single component. The hot air compressed by this second compressor 221 is stored in the tank 220 in the form of cold compressed air and heat. This air compression with storage may be performed via a known technique, such as for CAES (Compressed Air Energy Storage) systems with underground or surface storage: [6].

Thus, in this facility, the coupling of the hydrogen production unit 200 with a nuclear reactor and its Rankine cycle as an ECS conversion system is performed by supplying electricity from the Rankine cycle, thermally by the injection of hot water/steam used by the coupling steam generator 202 and by returning heat to the Rankine cycle to recover at least a portion of the waste heat, i.e. the heat emitted by the HTE unit 201 that was not used for the electrolysis reaction, by a reinjection coupling circuit comprising the first, second and third intermediate heat exchangers 205, 208, 218.

Thermal coupling is also performed with the thermal and pneumatic storage tanks 219, 220 via the coupling steam generator 202 and the coupling steam exchanger 222, respectively.

Regardless of how the facility functions, the HTE unit 201 operates at its nominal point, as does the Rankine cycle, which has relatively limited thermal modulation.

The different operating modes of the facility will now be explained.

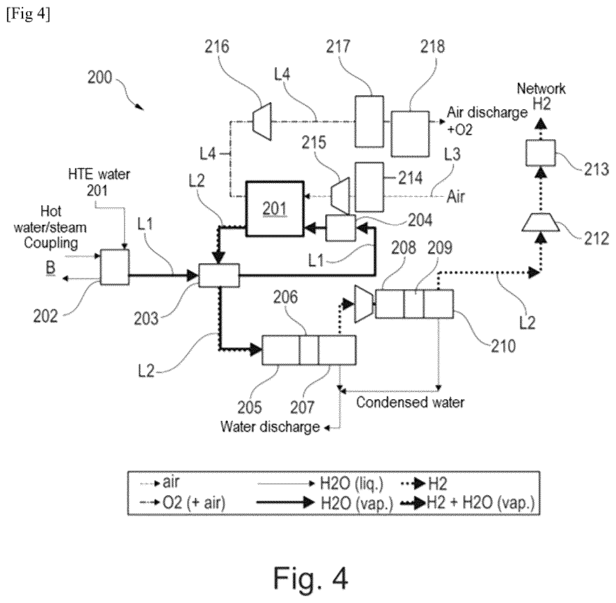

The nominal operating mode, i.e. with a nominal electrical power required by the electricity grid, is illustrated in FIG. 4.

In this nominal operating mode, no thermal storage or release from storage is performed. Thus, as illustrated in FIG. 4, there is no effective thermal coupling between the steam generator 202 and the thermal storage tank 219. The same also applies between the heat exchanger 222 and the pneumatic and thermal storage tank 220.

The HTE unit 201 receives electricity from the Rankine cycle alternator.

The hot water/steam supplied by the steam generator 202 feeds the cathodes of the HTE unit 201, while the compressed and heated air from the compressor 215 feeds the anodes of the HTE unit 201.

The waste heat from the HTE unit 201 is returned to the Rankine cycle via intermediate heat exchangers 205, 208, 218.

The pressure energy during expansion through the turbine 216 is sent as electricity to the Rankine cycle.

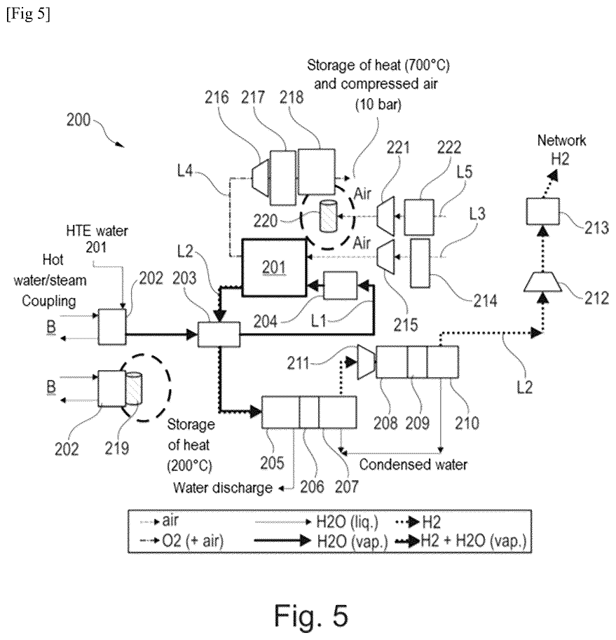

The charging operating mode of the facility, corresponding to a situation in which the amount of electricity required by the electricity grid is lower than that in the nominal operating mode, is illustrated in FIG. 5.

Here, additional electricity is supplied by the Rankine cycle to electrically power the second air compressor 221.

The hot air compressed by this second air compressor 221 is stored in the form of cold compressed air and heat in the tank 220. As indicated in this FIG. 5, the hot compressed air at 700° C. transfers its heat to a heat storage unit, reaching a temperature of 200° C. This compressed air, known as “cold” air, is stored.

Heat supplied by the coupling exchanger 202 is used to preheat the air entering this second compressor 221.

At the same time, heat supplied by the coupling generator 202 is stored in the thermal storage tank 219.

The heat supplied by both the steam generator 202 and the heat exchanger 222 is thus drawn from the Rankine cycle, resulting in lower electricity production by the latter.

As illustrated in this FIG. 5, the HTE unit 201 and the rest of the fluid circuits, in particular the heat return via the intermediate heat exchangers 205, 208, 218, operate in an identical manner to the nominal operating mode.

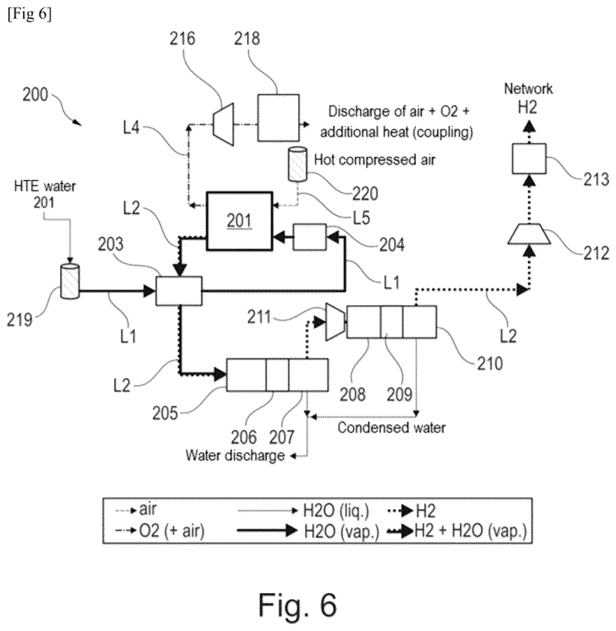

The discharging operating mode of the facility, corresponding to a situation in which the amount of electricity required by the electricity grid is greater than that in the nominal operating mode, is illustrated in FIG. 6.

The HTE 201 unit operates in an identical manner to the nominal operating mode.

However, the supply of pressurized hot air to the anodes of the HTE unit 201 is performed exclusively from the thermal and pneumatic storage tank 220.

The heat required for vaporization of the water so as to feed the cathodes of the HTE unit 201 is supplied exclusively by the heat storage tank 219.

Finally, the return of heat to the Rankine cycle is increased at the outlet of turbine 216 by the intermediate heat exchanger 218.

The heat supplied by the tank 219 and the heat removed by the intermediate heat exchanger 218 constitute reduced heat withdrawals from the Rankine cycle relative to the nominal operating mode. These cancelled withdrawals result in higher electricity production.

As illustrated in this FIG. 6, the HTE unit 201 and the rest of the fluid circuits, in particular the heat return via the intermediate heat exchangers 205 and 208, operate in an identical manner to the nominal operating mode.

By way of illustrative example, the HTE unit 201 may be operated at a pressure of 10 bar, based on an initial stable thermal power of the Rankine cycle of about 540 MWth.

The inventors also quantified, by way of indicative example, the heat balance of the hydrogen production unit 200 described above.

Example 1: The inventors considered an oxygen content at the outlet of unit 201 of 40%, for an electrical power of this unit of about 180 MWe.

The power modulations with the charging and discharging operating modes are then as follows
modulation of electrical power following the functioning of the second air compressor 221: −20 MWe (charging);
modulation of electrical power following the charge reduction of the second air compressor 221: +20 MWe (discharging);
modulation of thermal power to the Rankine cycle following the filling of the thermal storage tanks 219, 220: −45 MWth, equivalent to −9 MWe (charging);
modulation of thermal power to the Rankine cycle following the cancellation of heat withdrawals and the additional return of calories by the intermediate exchangers 205, 208, 218: +45 MWth, equivalent to +9 MWe (discharging).

Overall, the net balance of these modulations is [−29;+29] MWe.

Example 2: The inventors considered an oxygen content at the outlet of unit 201 of 25%, for an electrical power of this unit of about 220 MWe.

The power modulations with the charging and discharging operating modes are then as follows
modulation of electrical power following the functioning of the second air compressor 221: −118 MWe (charging);
modulation of electrical power following the charge reduction of the second air compressor 221: +118 MWe (discharging);
modulation of thermal power to the Rankine cycle following the filling of the thermal storage tanks 219, 220: −60 MWth, equivalent to −12 MWe (charging);
modulation of thermal power to the Rankine cycle following the cancellation of heat withdrawals and the additional return of calories by the intermediate exchangers 205, 208, 218: +60 MWth, equivalent to +12 MWe (discharging).

Overall, the net balance of these modulations is [−130; +130] MWe.

The invention is not limited to the examples just described; notably, features of the illustrated examples may be combined in non-illustrated variants.

Other variants and embodiments may be envisaged without departing from the context of the invention.

The cogeneration facility just described in relation to a pressurized water nuclear reactor may of course be used with all nuclear reactors with an indirect thermodynamic cycle, for which the heat production cycle is physically separated from the energy conversion cycle, such as a boiling water reactor or a fourth-generation nuclear reactor.

Thus, although the detailed example relates to a conventional pressurized water reactor, a cogeneration facility may be envisaged with a reactor of large or smaller size (SMR).

### LIST OF REFERENCES CITED

[1]: Improving energy efficiency by using cogeneration in electricity production” Jean-Marie Loiseaux, Henri Safa, Bernard Tamain, Réseau Sauvons le Climat.
[2]: Fujiwara et al. “Hydrogen production by high temperature electrolysis with nuclear reactor”, Progress in Nuclear Energy 50 (2008).
[3]: Richard D. Boardman et al. “Developing a low-cost renewable supply of hydrogen with high-temperature electrochemistry”, MRS Bulletin, volume 47, March 2022, mrs.org/bulletin.
[4]: 2006; 16 p; WHEC16: 16. World Hydrogen Energy Conference; Lyon (France); 13-16 Jun. 2006; Available from AFH2, 28 rue Saint Dominique 75007 Paris (France); https://inis.iaea.org/search/search.aspx?orig_q=RN: 38099968
[5]: “Dynamic performance analysis of a high-temperature steam electrolysis plant integrated within nuclear-renewable hybrid energy systems”. Applied Energy Volume 228, 15 Oct. 2018, pages 2090-2110. https://doi.org/10.1016/j.apenergy.2018.07.060.
[6]: “Underground storage of compressed air in the context of the energy transition”, INERIS STUDY REPORT Nov. 1, 2016 DRS-16-149645-00148A. https://www.ineris.fr/sites/ineris.fr/files/contribution/Documents/rapport-caes-v7-unique-1453211310.pdf

1. A cogeneration facility, intended for producing electricity and hydrogen, comprising:
at least one thermal power plant comprising a system for converting the heat produced by the power plant into electricity (ECS), connected to an electricity grid;
at least one hydrogen production unit comprising:
a fluid circuit, called the injection coupling circuit, for thermally coupling the hydrogen production unit to the thermal power plant, comprising:
at least one steam generator, called the coupling steam generator, connected in a closed loop to a withdrawal branch connection, made in a fluid branch of the ECS conversion system,
at least one first heat exchanger, called the coupling exchanger, connected in a closed loop to a withdrawal branch connection, made in a fluid branch of the ECS conversion system;
at least one high-temperature electrolysis HTE unit, whose cathodes are connected to the coupling steam generator;
at least one first air compressor connected to the anodes of the HTE unit;
a thermal and pneumatic storage system comprising:
at least one thermal storage tank connected on the one hand to the coupling generator and on the other hand to the cathodes of the HTE unit;
at least one second air compressor connected to the coupling exchanger,
at least one thermal and pneumatic storage tank connected, on the one hand, to the second air compressor and, on the other hand, to the anodes of the HTE unit;
the cogeneration facility being configured such that:
in the nominal operating mode of the facility, the cathodes of the HTE unit are supplied with pressurized steam produced by the coupling steam generator, while the anodes of the HTE unit are supplied with compressed air by the first compressor;
in the operating mode of the facility with an amount of electricity required by the electricity grid that is less than that in the nominal operating mode, called the charging operating mode, the cathodes of the HTE unit are supplied with pressurized steam produced by the coupling steam generator, while the anodes of the HTE unit are supplied with air compressed by the first compressor, and simultaneously, the thermal storage tank is supplied with heat from the coupling generator and the thermal and pneumatic storage tank is supplied with hot air compressed by the second compressor;
in the operating mode of the facility with an amount of electricity required by the electricity grid that is greater than that required in the nominal operating mode, called the discharging operating mode, the cathodes of the HTE unit are supplied with pressurized steam produced by the heat from the thermal storage tank, while the anodes of the HTE unit are supplied with hot compressed air supplied by the thermal and pneumatic storage tank.

2. The cogeneration facility according to claim 1, wherein the at least one thermal power plant is a pressurized water nuclear reactor (PWR) or a boiling water reactor (BWR).

3. The cogeneration facility according to claim 1, in which the first compressor and the second compressor are a single air compressor.

4. The cogeneration facility according to claim 1, wherein the first compressor is different from the second compressor, the first and second compressors being connected in parallel to the anodes of the HTE electrolysis unit and to the thermal and pneumatic storage tank, respectively.

5. The cogeneration facility according to claim 1, wherein the hydrogen production unit is also thermally coupled to the nuclear reactor by a fluid circuit, called the reinjection coupling circuit, comprising at least one intermediate heat exchanger, called the coupling exchanger, connected on the one hand in a closed loop to a reinjection branch connection made on a fluid branch of the ECS conversion system, and on the other hand to at least one fluid branch at the outlet of the high-temperature electrolysis unit, so as to at least partly evacuate the excess heat from the high-temperature electrolysis unit and reinject it into the ECS conversion system.

6. The cogeneration facility according to claim 5, wherein the reinjection coupling circuit comprises at least one coupling exchanger connected to a fluid branch whose inlet is connected to the outlet of the cathodes of the HTE electrolysis unit and whose outlet is connected to at least one network for evacuating the hydrogen produced.

7. The cogeneration facility according to claim 6, comprising at least one cooler connected downstream of the coupling exchanger and a gas-liquid phase separator connected downstream of the cooler to extract and condense the water contained in the mixture of hydrogen produced and steam at the outlet of the cathodes of the HTE unit.

8. The cogeneration facility according to claim 7, comprising at least two coupling exchangers in series with each other, and downstream of each of them, a cooler and a gas-liquid phase separator, and a compressor between the most upstream gas-liquid phase separator and the most downstream coupling exchanger.

9. The cogeneration facility according to claim 5, wherein the reinjection coupling circuit comprises at least one coupling exchanger connected to a fluid branch whose inlet is connected to the outlet of the anodes of the high-temperature electrolysis unit and whose outlet is connected to at least one network for evacuating the oxygen produced.

10. The cogeneration facility according to claim 1, comprising a turbine on a fluid branch whose inlet is connected to the outlet of the anodes of the high-temperature electrolysis unit and whose outlet is connected to at least one network for evacuating the oxygen produced.

11. The cogeneration facility according to claim 1, comprising an electrical resistor for, in the discharging operating mode, heating the air released from the pneumatic and thermal storage tank before it enters the anodes of the HTE unit.

12. The cogeneration facility according to claim 1, comprising a turbine on a fluid branch whose inlet is connected to the pneumatic and thermal storage tank and whose outlet is connected to the outlet of the anodes of the HTE electrolysis unit for, in the discharging operating mode, expanding the air released from the pneumatic and thermal storage tank before it enters the anodes of the HTE unit.

13. The cogeneration facility according to claim 1, comprising a compressed hydrogen storage tank connected to the outlet of the cathodes of the HTE unit.

14. The cogeneration facility according to claim 1, comprising a compressed oxygen or air-oxygen mixture storage tank connected to the outlet of the anodes of the HTE unit.

15. The cogeneration facility according to claim 1, in which the electricity grid is configured to supply, in nominal and charging operating modes, most of the electricity required by the HTE unit.
